(19) United States
(12) Patent Application Publication
(10) Pub. No.: US 2004/0242248 A1
(43) Pub. Date: Dec. 2, 2004

(54) Method and apparatus for fast network acquisition

(75) Inventors: Mark A. Goldberg, Davie, FL (US); Jean Khawand, Miami, FL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/449,449

(22) Filed: May 30, 2003

(51) Int. Cl. H04Q 7/20

(52) U.S. Cl. 455/502; 455/500; 370/350

(57) ABSTRACT

A method and apparatus for fast network acquisition suitable for use in a wireless communications unit that includes an antenna (10), a synthesizer (12), a receiver (14), a transmitter (15) and a controller (7). The antenna (10) receives a wideband signal (18) corresponding to a wideband channel including a plurality of narrower band channels. The controller (7) searches a base band signal (32) provided by the receiver (14) by dividing it into intermediate signals (124a-124d) corresponding to the plurality of narrower band channels to find narrower band channels with a synchronization pattern, and attempts to locate control channels corresponding to a base station server (6) within the narrower band channels with the synchronization pattern. One of the control channels having a most favorable signal characteristic is selected as an appropriate control channel and the transmitter (15) facilitates registration with a wireless network corresponding to the appropriate control channel.

### FIELD OF THE INVENTION

This invention relates in general to wireless communications units, and more specifically to a method and apparatus for fast network acquisition for use in wireless communications units.

### BACKGROUND OF THE INVENTION

Network acquisition is the process through which a wireless communications unit locates and synchronizes to a wireless network. Specifically, network acquisition includes cell or control channel selection and is the process used by the wireless communications unit to locate a suitable base station server in order to synchronize to and access the wireless network. The time required by the network acquisition process is dominated by the time it takes the wireless communications unit to find a beacon signal from a suitable base station server.

In typical cell selection, the wireless communications unit scans through a list of frequency channels or possible control channels, otherwise known as a bandmap, that is maintained in a memory associated with a microprocessor until a frequency channel with a synchronization pattern (sync pattern) is detected. The wireless communications unit decodes a portion of a signal corresponding to the frequency channel with the sync pattern to determine if the frequency channel is a control channel. If the frequency channel is a control channel, the wireless communications unit follows a registration procedure to gain access to the wireless network that corresponds to the control channel. If the frequency channel is not a control channel, the wireless communications unit continues the scan of the bandmap until a control channel is found.

In recent years, a demand for high speed data services has given rise to the proliferation of new systems as well as wireless hardware and software capable of processing radio signals with increased bandwidth compared to that needed for conventional voice telephony. However, the typical cell selection protocol for such wideband systems still depends on serially searching a large number of narrower band channels for a control channel. One problem is that with a large number of possible channels, the time required for the network acquisition process may be long. A user of the wireless communications unit may experience an undesirable waiting period while a wireless network is being located and accessed. For example, if a bandmap includes 150 different frequencies and the wireless communications unit spends 43-93 ms to scan a single frequency to detect the sync pattern and identify the channel type, in the worst case situation, i.e. all bandmap frequencies are scanned fo the maximum interval, the user may wait for up to 14 seconds before network registration begins.

Therefore, what is needed is a method and apparatus for fast network acquisition for use in wireless communications units with wideband applications.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, in a simplified and representative form, a system environment suitable for utilization of various embodiments of fast network acquisition for a wireless communications unit;

FIG. 2 depicts, in a representative form, a block diagram of a preferred embodiment of the wireless communications unit for fast network acquisition;

FIG. 3 depicts, in a simplified and representative form, a flow diagram of a method for fast network acquisition;

FIG. 4 illustrates a more detailed flow diagram of a preferred embodiment of a portion of the FIG. 3 method;

FIG. 5 depicts, in a representative form, a block diagram of a portion of the wireless communications unit for fast network acquisition corresponding to a synchronization search;

FIG. 6 depicts a block diagram of a portion of the wireless communications unit for fast network acquisition corresponding to a control bit search; and

FIG. 7 illustrates a frequency domain view corresponding to a synchronization search.

### DETAILED DESCRIPTION OF PREFERRED EMBODIMENT

In overview, the present disclosure concerns wireless communications units, and more specifically methods and apparatus for network acquisition within such units. More particularly, various inventive concepts and principles that can improve the performance and reduce the time required for network acquisition are discussed.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions or application specific integrated circuits and associated processors. It is expected that one of ordinary skill, notwithstanding possibly significant effort and many design choices motivated by, for example, available time, current technology, and economic considerations, when guided by the concepts and principles disclosed herein will be readily capable of generating such software instructions or integrated circuits with minimal experimentation. Therefore further discussion of such software or integrated circuits, if any, will be limited in the interest of brevity and minimization of any risk of obscuring the principles and concepts in accordance with the present invention.

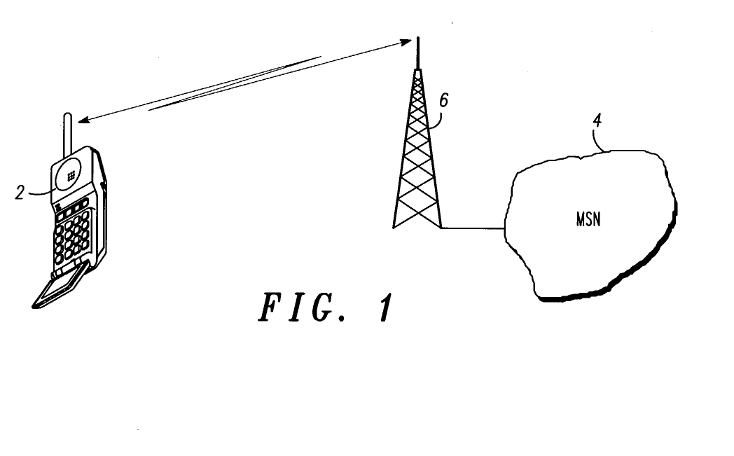

Referring to the figures and specifically to FIG. 1, a system environment suitable for utilization of various embodiments of fast network acquisition for a wireless communications unit 2 is shown. The wireless communications unit 2 may be any type of wireless phone, data or messaging unit such as, for example, a time division multiple access (TDMA) or GSM type cellular telephone, or other wireless phone such as an integrated digital enhanced network unit that is capable of communicating with other like wireless units or with public switched telephone network landline devices over a mobile switching network, otherwise known as a wireless network 4, through a base station or base station server 6.

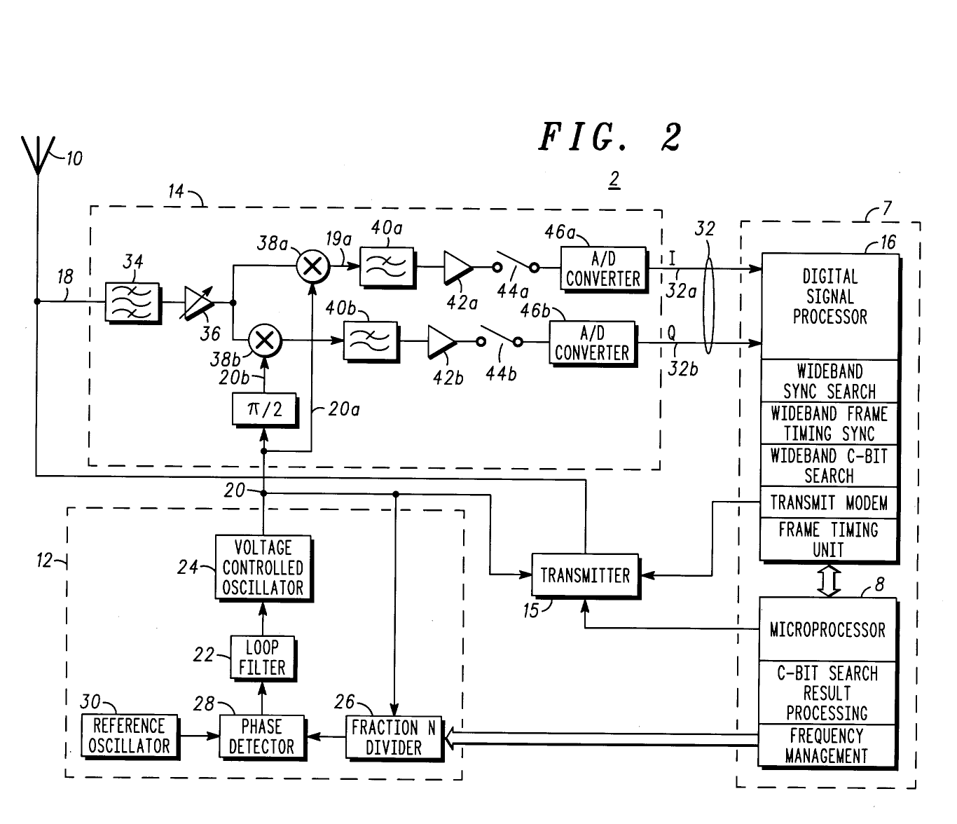

Referring now to FIG. 2, a block diagram of a preferred embodiment of the wireless communications unit 2 is shown. In addition to including a controller 7, the wireless communications unit 2 includes a conventional antenna 10, a synthesizer 12, a receiver 14, and a transmitter 15 all inter coupled as depicted. The makeup and function of each of these components will now be discussed in detail.

The antenna 10 is for receiving radio frequency (RF) energy from the wireless network 4, and for coupling the RF energy to the receiver 14. The antenna 10 is also coupled to the transmitter 15, and operates to or for emitting RF energy supplied by the transmitter and intended for the wireless network 4.

The receiver 14 is for receiving a wireless network wideband signal at terminal 18 that corresponds to a wireless network wideband channel or more specifically a plurality of channels from the wireless network as represented by the RF energy received at the antenna 10. The wideband channel includes a plurality of frequency channels, otherwise known as a plurality of narrower band channels one or more of which may be a control channel. The receiver 14 is further for processing the wideband signal 18 using an injection signal 20 generated by the synthesizer 12 to provide the base band signal 32.

As will be appreciated by those skilled in the art, various gain stages, filters, mixers and converters are included in the receiver 14 and can be configured in a number of ways while maintaining similar functionality. For example, as shown in FIG. 2, the receiver 14 includes a filter 34 that is preferably a band pass filter for filtering the wideband signal 18 to reject undesired out of band signals, a variable gain amplifier 36 designed to amplify and regulate and therefore maintain an appropriate level of the wideband signal 18, that is applied to mixers 38a, 38b all inter coupled as depicted in FIG. 2. The injection signal 20 provided by the synthesizer 12 is separated into a first injection signal 20a and a second injection signal 20b having a phase difference of π/2 each with a frequency centered within the wideband channel thereby converting the wideband signal to a zero or near zero intermediate frequency signal. The wideband signal 18 is down converted in the mixer 38a using the first injection signal 20a to produce an in-phase signal 19a. The wideband signal is down converted in the mixer 38b using the second injection signal 20b to produce a quadrature signal 19b. The in-phase and quadrature signals 19a, 19b are processed or filtered by filters 40a, 40b to remove extraneous noise and unnecessary components of the signals at the output of the mixers and then are processed or amplified by amplifiers 42a, 44b. The signals at the output of the amplifiers are sampled by samplers 44a, 44b before being digitized in analog to digital converters 46a, 46b to become a processed in-phase signal 32a and a processed quadrature signal 32b. The digitized in-phase signal 32a and the digitized quadrature signal 32b are output to the controller 7 as the base band signal 32.

The controller 7 is coupled to the receiver 14 and is for processing the base band signal to search for a control channel among the plurality of narrower band channels. As will be appreciated by those skilled in the art, the controller 7 could be implemented in a number of ways while maintaining similar functionality. The controller 7 includes one or more processors such as microprocessors or digital signal processors (DSP) and preferably a microprocessor and a DSP. The microprocessor and the DSP each have an integral memory and may have an associated but separate memory, the memory comprising devices in some combination of RAM, ROM, EEPROM, or the like. In a preferred embodiment, the controller 7 includes a microprocessor 8, which is preferably a conventional multi-purpose microprocessor, such as an MCORE family processor, and a digital signal processor (DSP) 16, which is preferably a 56600 Series DSP each available from Motorola, Inc.

The microprocessor 8, specifically associated or integral memory, among other data, is arranged for storing a frequency bandmap, or list of narrower band channels, one or more that the wireless communications unit 2 may ultimately use to connect to or access the network 4 through the base station server 6. The microprocessor 8 also executes software to provide overall control for the communications unit as is known and more specifically for functions or operations such as communicating with the DSP 16, setting, by programming the synthesizer 12, a receive frequency of the receiver that is nominally centered in the wideband signal 18, providing instructions to the synthesizer 12 based on the frequency bandmap and reading and interpreting system information. The microprocessor 8 is also for prioritizing control channels to decide which narrower band channel or control channel the wireless communications unit should use to connect to or access the network 4, e.g. for selecting an appropriate control channel corresponding to the base station server 6.

The DSP 16 is for obtaining or receiving the base band signal 32 from the receiver 14 and for further processing the base band signal 32. More specifically, the DSP 16 searches for a narrower band channel that has a known or predetermined synchronization pattern (known sync pattern or sync pattern) and time aligns the receiver 14 to the narrower band channel with the sync pattern. The DSP 16 may search for a narrower band channel that has a particular one of a set of known synchronization patterns with other channels having other sync patterns, however, in a preferred embodiment one known sync pattern is used. The DSP 16 further determines if the narrower band channel with the sync pattern is a control channel.

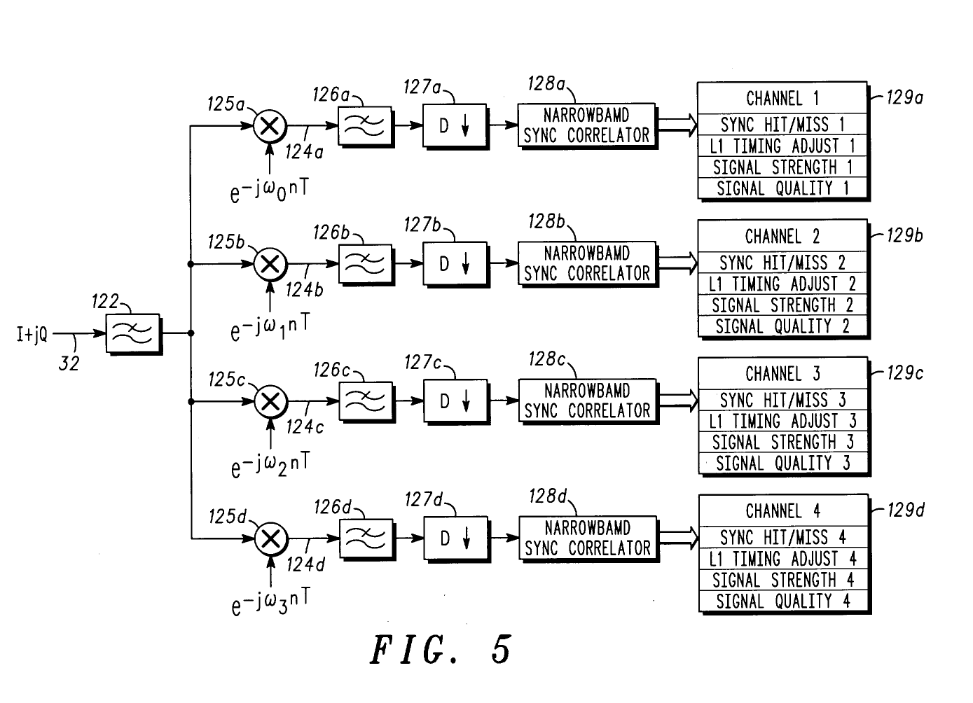

The DSP 16 is also for processing the base band signal 32 to search for a plurality of narrower band channels that have the sync pattern and for time aligning the receiver to the narrower band channels with the sync pattern using the frame timing unit (FTU) or function. The FTU uses a precision timer, software, and the wideband sync searcher, and is preferably implemented in the DSP. The FTU is programmed to have a period that is equal to the wireless network's frame period where network base stations are frame aligned. When the receiver is operating in frame sync a count from the FTU precison timer is coincident with the network's frame boundary. In this synchronized condition, the interval from the time the receiver is enabled to the time the sync correlation peak occurs, Tk, is constant and equal to the signal delay through the receiver plus the delay through the sync correlator. Since the interval Tk depends only on the receiver and sync correlator design it can be pre-stored. The FTU uses Tk to attain frame sync as described below. Each time the wireless communications unit scans for sync the Wideband Sync Searcher measures the interval from the time the receiver is enabled until the time the sync correlation peak occurs. The measured interval is called Tk′. The sync correlator (FIG. 5) compares the measured interval Tk′ to the pre-stored, expected interval Tk and computes timing error Te=Tk−Tk′. The FTU adjusts the period of the timer by −Te on the subsequent frame, thereby canceling out the timing error and thus achieving frame synchronization. The adjustment −Te is referred to as ‘L1 Timing Adjust’ on FIG, 5.

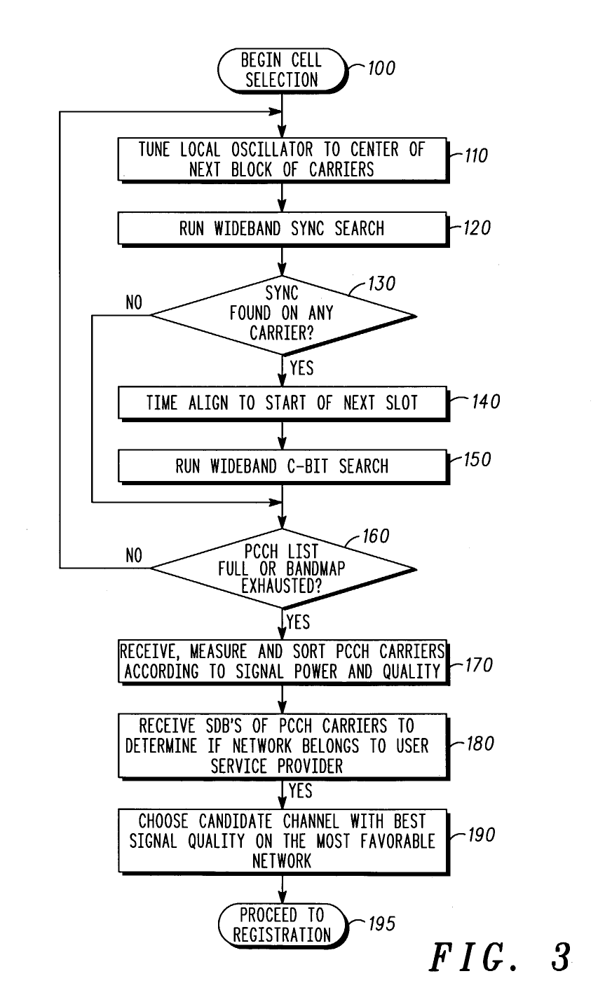

The controller 7 is further for searching for a plurality of control channels among the plurality of narrower band channels and, when found, for prioritizing the plurality of control channels. This prioritizing may be implemented in a number of ways, for example and preferably the DSP 16 measures one or more signal characteristic corresponding to each of the plurality of control channels and orders the plurality of control channels in accordance with the signal characteristic. The functionality of the controller 7 will be discussed in further detail below with reference to FIGS. 3-6.

The synthesizer 12 may be any type of synthesizer that is capable of providing a signal for down converting a carrier signal to produce and output or otherwise provide an injection signal 20 to the receiver 14 based on instructions from the microprocessor 8. In the preferred form the synthesizer 12 is a known fractional N synthesizer and includes a loop filter 22, a voltage controlled oscillator (VCO) 24, a fractional-N (frac-N) divider 26, a phase detector 28 and a reference oscillator 30 inter coupled as depicted in FIG. 2. By appropriately programming the frac-N divider the frequency out of the VCO 24 can be set to a desired value. The microprocessor 8 uses the synthesizer with the VCO 24 to provide the injection signal 20 to properly down convert the narrower band channels in the wideband signal at terminal 18 and to otherwise establish the receive and transmit frequencies on which the wireless communications unit 2 operates.

The transmitter 15 cooperatively operates with the controller 7 and the receiver 14 when the control channel is found to facilitate registration with the wireless network 4 over the control channel in a known manner that varies with the particular access technology conventions. Specifically, the transmitter 15 requires coding, forward error correction and the like usually performed by a transmit modem function, up-converting using the injection signal 20 from the synthesizer 12 and mixers, more or less in the reverse order of the operations that are done in the receiver 14. The transmitter 15 as noted above is coupled to the antenna 10 and is further controlled by the microprocessor 8. Transmitters such as the transmitter 15 are well known in the art, therefore, the functionality of the transmitter 15 will not be discussed in further detail.

Referring now to FIG. 3, a flow diagram of a method for fast network acquisition according to the present invention is shown. Specifically, the flow diagram shown in FIG. 3 describes a methodology or process for control channel or cell selection that is executed in the controller 7. In a preferred embodiment, the process is implemented by software programmed into at least one of the DSP 16 and the microprocessor 8.

Specifically, at 100, the controller 7 or microprocessor and DSP 16 begins the cell selection process. It should be noted that the wireless communications unit 2 continually receives RF energy at the antenna 10 and processes the signal in the receiver 14 using a new injection signal from the synthesizer 12 to continually produce new base band signals corresponding to new wideband channels so long as a control channel is being sought. The search for a control channel or cell selection method operates as follows.

At 110 the microprocessor 8 tunes a local oscillator (LO) to the center of the wideband signal comprising a block of carriers and the base band signal 32 is provided from the receiver 14. At 120, the controller 7, specifically DSP 16, searches the base band signal 32 to find narrower band channels with the known sync pattern.

Referring to FIGS. 2, 3 and 5, the search begins with the DSP 16 band limiting the base band signal 32 using a low pass filter 122. The base band signal 32 as filtered is separated into intermediate signals 124a-124d corresponding to each of the plurality of narrower band channels by mixing the base band signal 32 in mixers 125a-125d with sinusoidal signals having frequencies corresponding to the narrow band channels or corresponding signals within the wideband signal. In this configuration, the DSP 16 is able to process the intermediate signals 124a-124d essentially in parallel. That is, instead of processing one signal corresponding to a narrower band channel such as, for example the intermediate signal 124a, at a time as is done in prior art controllers, the DSP 16 has the capability to process all of the intermediate signals 124a-124d corresponding to the plurality of narrower band channels within the wideband signal concurrently. For each sample of processing block of the wideband signal the DSP 16 searches all of the narrower band channels. In this manner the DSP 16 is able to search through all or some of the narrower band channels in the frequency bandmap much more quickly than prior art controllers. In this manner, the DSP 16 can more rapidly search the base band signal 32 and, ultimately the frequency bandmap, to determine whether one or more of the plurality of narrower band channels includes the sync pattern and is further a control channel.

In any event each of the intermediate signals 124a-124d is centered, utilizing a corresponding one of a plurality of mixers 125a-125d or a multiplication function of the DSP to combine or mix the base band signal with a corresponding one of a plurality of sinusoidal waveforms to produce each of the intermediate signals 124a-124d. Each of the intermediate signals 124a-124d is isolated with respect to the other narrower band channels, preferably using filters 126a-126d. The sampling rates of the intermediate signals 124a-124d are reduced in a respective one of a plurality of decimators 127a-127d to decrease the processing power required in the DSP 16 and the microprocessor 8.

Each of the intermediate signals 124a-124d is then compared with the known sync pattern in a respective one of a plurality of narrow band sync correlators 128a-128d. Based upon the results of the comparison or correlation, the plurality of narrow band sync correlators 128a-128d determines whether each narrower band channel has the sync pattern, and a record of which of the narrower band channels have the sync pattern is kept in the controller 7, preferably in data tables 129a-129d. One or more signal characteristics such as signal strength or signal quality may also be measured or assessed by the DSP or microprocessor 8 and recorded or stored in the memory as the data tables 129a-129d.

Referring again to FIG. 3, at 130 the DSP 16 determines if a portion of one or more of the plurality of narrower band channels or carriers includes the sync pattern. If no narrower band channels are found with the sync pattern and the list is not full or bandmap exhausted as determined at 160, the microprocessor 8 returns to repeat the tuning of the LO or VCO to a new frequency corresponding to a new wideband signal at 110, the DSP 16 receives a new base band signal corresponding to the new wideband channel from the receiver 14 and searches the new base band signal for narrower band channels with the sync pattern at 120. When the DSP 16 determines that it has located a portion of the plurality of narrower band channels with the sync pattern at 130, at 140 the DSP 16 time aligns the receiver to the narrower band channel or the portion of the plurality of narrower band channels with the sync pattern to the start of the next transmission slot for the synchronization pattern for the corresponding narrower band channel or carrier. This is accomplished by adjusting a frame timing unit and value in accordance with the timing adjustment values from the tables 129a-129d as earlier recorded.

Referring to FIGS. 2, 3, 5 and 6, at 150, the DSP 16 attempts to locate narrower band channels having the sync pattern that also have control bits (C bits) and are therefore control channels. This process is referred to as a C bit search and is an extension of the earlier sync search and processing.

The base band signal 32 continues to be supplied from the receiver 14 and band limited by the low pass filter 122. As in the synchronization searching functionality of the DSP 16, each of the intermediate signals 124a-124d is centered utilizing one of the plurality of mixers 125a-125d and one of a plurality of sinusoidal waveforms. Each of the intermediate signals 124a-124d is isolated with respect to the other narrower band channels, preferably utilizing one of a plurality of filters 126a-126d. The sampling rate of the intermediate signals 124a-124d is reduced in one of a plurality of decimators 127a-127d to decrease the processing power required in the DSP 16 and the microprocessor 8.

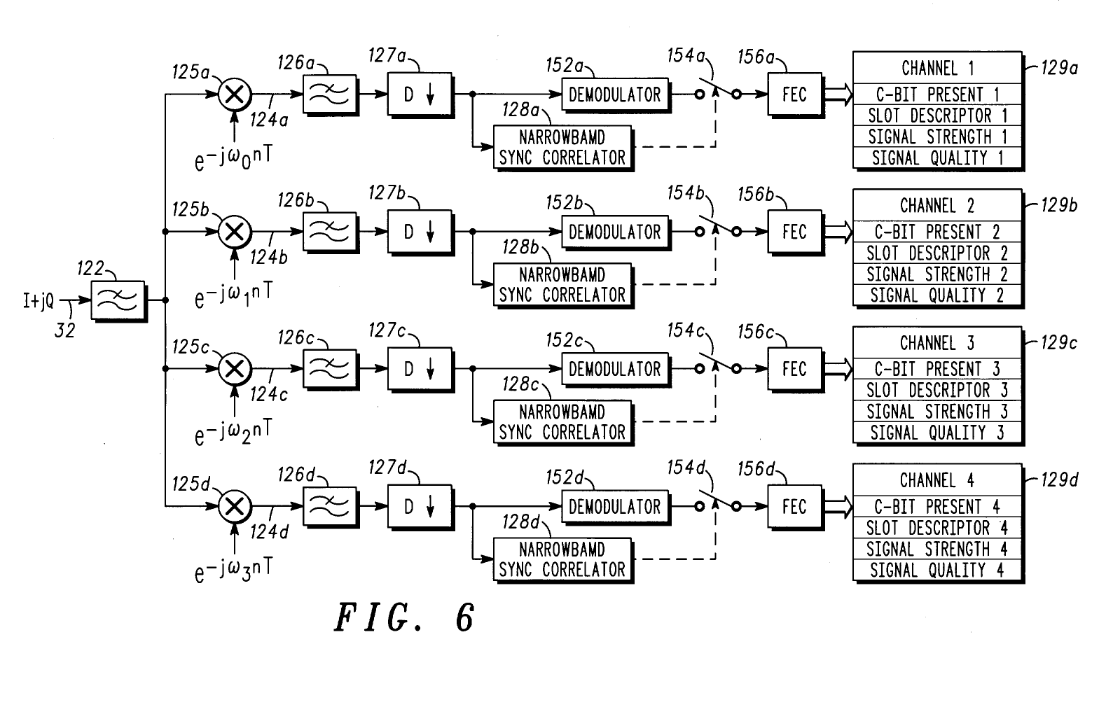

It should be noted that the methods of centering and isolating each of the plurality of narrower band channels and reducing the sampling rate of the intermediate signals 124a-124d could be performed by any number of software algorithms or hardware implementations in addition to those described above with respect to FIGS. 5 and 6.

In FIG. 6, after having its sampling rate reduced in one of the plurality of decimators 127a-127d, a first portion of the intermediate signals 124a-124d (first portion often referred to as a preamble) is compared with the known sync pattern to derive symbol timing synchronization in one or more of the plurality of narrow band sync correlators 128a-128d. A second portion of the intermediate signals 124a-124d (second portion) is then demodulated in one or more of a plurality of demodulators 152a-152d. The second portion as demodulated is sampled in one or more of a plurality of samplers 154a-154d based on the sync correlation of the first portion as determined by the one or more of the plurality of narrow band sync correlators 128a-128d. Therefore, the output of each of the plurality of samplers 154a-154d is an estimated signal representative of one of the narrower band channels. Errors in the estimated signal caused by factors such as noise, fading and the like are detected/corrected in one of a plurality of forward error correctors (FECs) 156a-156d.

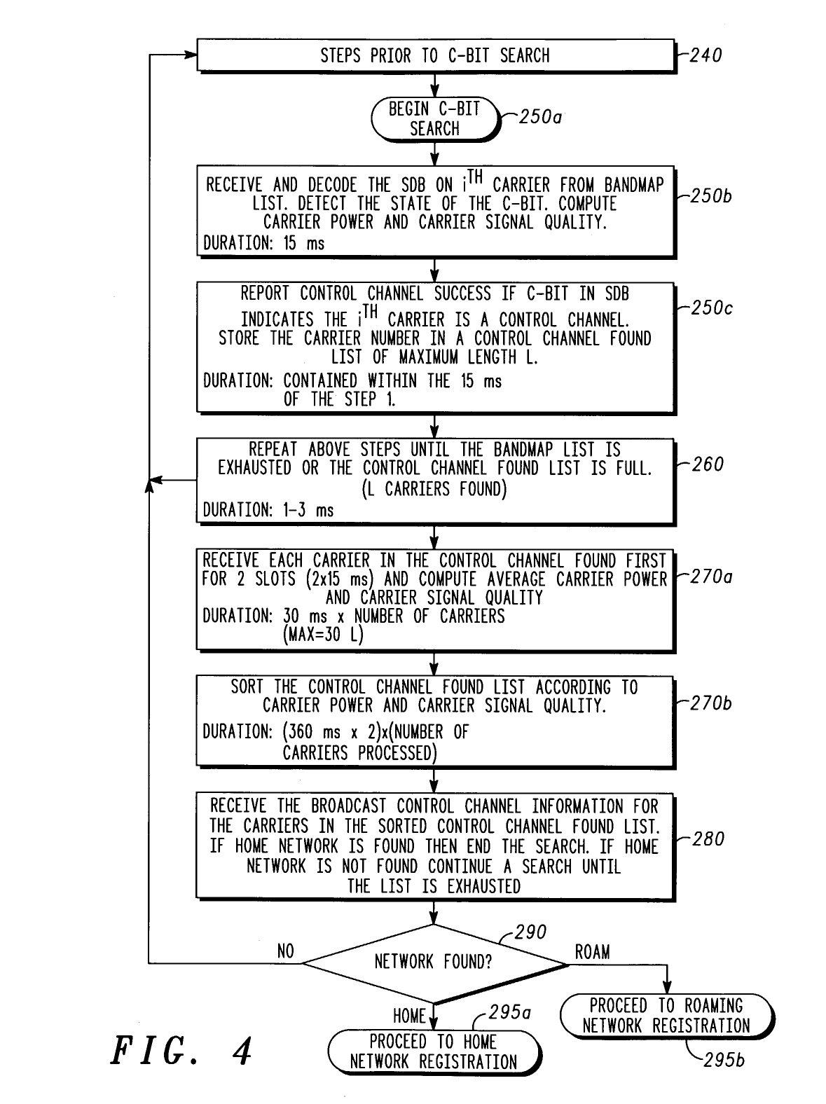

Referring now to FIG. 4, a more detailed flow diagram of a portion of the FIG. 3 method will be discussed. Specifically, the processing performed at 100-140 in FIG. 3 is represented at 240 in FIG. 4. At 250a-250c, FIG. 4 details the processing performed at 150 in FIG. 3. The processing at 260 in FIG. 4 corresponds to the processing at 160 in FIG. 3. At 270a-270b, FIG. 4 details the processing performed at 170 in FIG. 3. The processing at 280, 290, and 295a-295b in FIG. 4 corresponds to the processing at 180, 190, and 195, respectively, in FIG. 3.

As shown in FIGS. 3, 4 and 6, at 250b the controller 7 decodes a portion of the corrected estimated signal. Specifically, the FECs 156a-156d or associated decoding functions thereof decode a slot descriptor block (SDB), or portion of the signal representative of what the rest of the corrected estimated signal contains. Each of the plurality of FECs 156a-156d also computes at least one signal characteristic corresponding to each of the corrected estimated signals such as a power factor or a signal quality factor. Each of the plurality of FECs 156a-156d determines which of the narrower band channels are control channels (note these narrower band channels have sync patterns) from the SDBs at 250c and reports these control channels or corresponding data to the data tables 129a-129d in the memory of the microprocessor 8. Preferably, the control channels of the present invention are primary control channels and therefore include broadcast system information, but applications utilizing other control channels such as associated control channels, dedicated control channels, and temporary control channels are within the scope of the present invention. At 250c, the microprocessor 8 formulates a control channel found list containing the narrower band channels that are control channels based on the data received, (C-bit present, etc.) from the DSP 16.

Referring back to FIGS. 3 and 4, at 260 the DSP 16 determines if at least one narrower band channel has a C bit and is therefore a control channel. If no narrower band channels are found that are control channels, the microprocessor 8 returns to repeat the tuning of the LO at 110, the DSP 16 receives a new base band signal from the receiver 14 and searches the new base band signal for narrower band channels with the sync pattern at 120. When the DSP 16 determines that at least one narrower band channel has the sync pattern at 130, at 140 the DSP 16 performs a time alignment of the at least one narrower band channel with its respective sync to keep a record of where in time the sync occurs and runs the C bit search at 150.

At 260, the DSP 16 continues to receive and process the new base band signals from the receiver 14 at 240-260 until the DSP 16 has attempted to locate control channels in all the frequencies within the frequency bandmap stored in the microprocessor 8 or a predetermined number, L=25-30 depending on application and designer preferences, of control channels are found.

At 270a, the DSP 16 receives each narrower band channel in the control channel found list, or each control channel, for two time periods, the time period typically being a time slot length in a TDMA system that will vary with the access technology as is known, and computes a signal characteristic corresponding to each control channel such as an average power factor or an average signal quality factor.

At 270b, the microprocessor 8 orders the control channels that have been located or discovered in accordance with the signal characteristic corresponding to each control channel to form a sorted control channel list.

At 280, the DSP 16 progressively receives the broadcast control channel (BCCH) information corresponding to the control channels in the sorted control channel list until a control channel containing a home network identifier corresponding to the base station server 6 (FIG. 1) is located or until a first iteration through all of the control channels is completed. In this manner, the control channel containing a home network identifier that is located first and is selected for registration will be the control channel of a home network with the most favorable signal characteristic, such as a highest average signal quality factor, otherwise referred to as an appropriate control channel. If the first iteration through all of the control channels is completed and a control channel with a home network identifier is not located, a control channel with a roaming network identifier and having the most favorable signal characteristic will be selected for registration. Note that there may be preferences even among roaming channels as is known and this will affect the search at 280.

At 290, the microprocessor 8 determines if a control channel has been selected for registration. If a first iteration through all of the control channels in the sorted control channel list is completed and neither a control channel having a home network identifier nor a control channel having a roaming network identifier is found, the controller 7 returns to repeat the cell selection process at 240, and more specifically at 110 in FIG. 3 If a control channel with a home network identifier is located, the microprocessor 8 reads system information and proceeds to enable registration of the wireless communications unit on the control channel in a home network registration at 295a. Otherwise, if a control channel with a roaming network identifier is located, the microprocessor 8 reads system information and proceeds to enable registration on the control channel in a roaming network at 295b.

Alternately, the DSP 16 may not allow registration of a roaming channel as the control channel. In other words, the DSP 16 progressively receives the BCCH information corresponding to the control channels in the sorted control channel list at 180 and at 280 until at least one suitable control channel containing a home network identifier corresponding to a base station server 6 is located or until a first iteration through all of the control channels in the control channel found list is completed. At 290, the microprocessor 8 determines if a suitable control channel having a home network identifier has been located. If a first iteration through all of the control channels in the sorted control channel list is completed and a suitable control channel having a home network identifier is not located, the controller 7 returns to repeat the cell selection process at 240. If a suitable control channel with a home network identifier is located, the microprocessor 8 selects an appropriate control channel, such as the control channel with the best signal quality, at 190 (FIG. 3) and proceeds to enable registration at 295a in FIG. 4.

When the microprocessor 8 has enabled registration of a control channel such as the appropriate control channel, the transmitter 15 facilitates registration with the wireless network 4 over the appropriate control channel.

In summary, the method and system for network acquisition provides parallel processing of intermediate signals corresponding to multiple narrower band channels to reduce the time needed to perform the cell selection process on a wideband signal. Specifically, a wideband signal corresponding to a wideband channel is divided into intermediate signals corresponding to a plurality of narrower band channels, and each narrower band channel is searched to see if it includes the sync pattern. The narrower band channels with the sync pattern are time aligned, control channels are located within the narrower band channels with the sync pattern and registration of one of the control channels corresponding to a base station server is enabled. This parallel processing provides for faster acquisition of an appropriate control channel, as prior art methods and systems provide for serial processing of multiple channels. The processes discussed above and the inventive principles thereof are intended to and will expedite network acquisition processes.

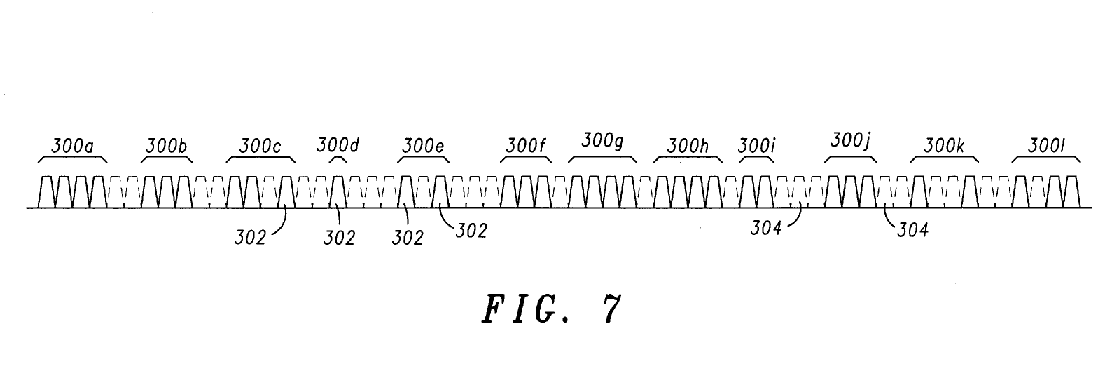

FIG. 7 illustrates a frequency domain view corresponding to a synchronization search according to the present invention. Specifically, FIG. 7 highlights the time savings according to the present invention by showing the time savings of one aspect of the method and system for fast network acquisition, specifically synchronization searching (sync searching), whereas the entire method and system includes further time saving aspects. As shown, the wireless communications unit 2 receives and searches for a narrower band channel with the sync pattern within the wideband signals 300a-300l. The wideband signals 300a-300l corresponding to wideband channels include at least one, and usually more than one, narrower band channel 302 (solid outline). Narrower band channels 304 (dotted outline) are not within the frequency bandmap that is stored in the microprocessor 8 and are therefore not received or if received not processed in terms of a sync search and the like. In this manner, the sync searching of the present invention is significantly more time efficient than conventional sync searching that requires that each narrower band channel 302 be received (synthesizer tuned to each respective narrower band channel) and processed individually.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A wireless communications unit arranged and constructed for fast network acquisition in a wireless network, the wireless communications unit comprising:
a receiver for receiving a wideband signal further comprising a plurality of narrower band channels from the wireless network to provide a base band signal;
a controller, coupled to the receiver, for processing the base band signal to search for a control channel among the plurality of narrower band channels; and
a transmitter cooperatively operating with the controller and receiver when the control channel is found, for facilitating registration with the wireless network over the control channel.

2. The wireless communications unit of claim 1, wherein the controller is further for dividing the base band signal so as to process signals corresponding to each of the plurality of narrower band channels in parallel.

3. The wireless communications unit of claim 1, wherein the controller is further for processing the base band signal to search for a narrower band channel having a synchronization pattern.

4. The wireless communications unit of claim 3, wherein the controller is further for time aligning the receiver to the narrower band channel having the synchronization pattern.

5. The wireless communications unit of claim 1, wherein the controller is further for searching for a plurality of control channels among the plurality of narrower band channels and, when found, further for prioritizing the plurality of control channels.

6. The wireless communications unit of claim 5, wherein the controller is further for determining a signal characteristic corresponding to each of the plurality of control channels and for ordering the plurality of control channels in accordance with the signal characteristic.

7. The wireless communications unit of claim 6, wherein the controller is further for selecting an appropriate control channel corresponding to a base station server from the plurality of control channels based on the signal characteristic corresponding to the plurality of control channels and wherein the transmitter is further for facilitating registration with the wireless network over the appropriate control channel.

8. The wireless communications unit of claim 1, wherein the controller is further for setting a receive frequency of the receiver that is nominally centered in the wideband signal.

9. The wireless communications unit of claim 1, wherein the control channel includes broadcast system information.

10. The wireless communications unit of claim 1, wherein the controller is further for decoding at least a portion of a signal corresponding to each of the plurality of narrower band channels to determine whether one of the plurality of narrower band channels is the control channel.

11. A software program for facilitating fast network acquisition for a wireless communications unit, the software program when installed and executing on a controller of the wireless communications unit resulting in:
searching a wideband signal from a wireless network, the wideband signal comprising a plurality of narrower band channels, to determine whether one of the plurality of narrower band channels includes a synchronization pattern; and
when one of the plurality of narrower band channels includes the synchronization pattern and is further determined to be a control channel, registering with a base station server corresponding to the control channel.

12. The software program of claim 11, wherein the searching of the wideband signal further determines that a portion of the plurality of narrower band channels include the synchronization pattern and are further determined to be control channels, the software program further resulting in the wireless communications unit selecting an appropriate control channel from the portion of the plurality of narrower band channels for registering with a base station server corresponding to the appropriate control channel.

13. The software program of claim 11, wherein the searching of the wideband signal further comprises dividing the wideband signal so as to process signals corresponding to each of the plurality of narrower band channels in parallel.

14. The software program of claim 13, further comprising comparing the signals corresponding to each of the plurality of narrower band channels with a known synchronization pattern to determine if any of the plurality of narrower band channels includes the synchronization pattern.

15. The software program of claim 13, wherein the searching of the wideband signal further comprises decoding at least a portion of the signals corresponding to each of the plurality of narrower band channels to determine whether the one of the plurality of narrower band channels including the synchronization pattern is the control channel.

16. The software program of claim 15, wherein the searching of the wideband signal further comprises correlating the signals corresponding to each of the plurality of narrower band channels including the synchronization pattern with a known synchronization pattern to derive symbol timing synchronization, demodulating a portion of the signals corresponding to each of the plurality of narrower band channels including the synchronization pattern, and correcting errors in the signals corresponding to each of the plurality of narrower band channels including the synchronization pattern in the decoding of at least a portion of the signals corresponding to each of the plurality of narrower band channels.

17. A method for fast network acquisition in a wireless communications device, the method comprising:
searching a wideband channel from a wireless network, the wideband channel comprising a plurality of narrower band channels, to find a narrower band channel having a synchronization pattern; and
determining whether the narrower band channel with the synchronization pattern is a control channel and, if so, registering with a base station server corresponding to the control channel.

18. The method of claim 17, wherein the searching of the wideband channel further comprises dividing a base band signal corresponding to the wideband channel so as to process signals corresponding to each of the plurality of narrower band channels in parallel.

19. The method of claim 17, wherein the determining of whether the narrower band channel with the synchronization pattern is the control channel further comprises decoding at least a portion of a signal corresponding to the narrower band channel with the synchronization pattern.

20. The method of claim 17, further comprising:
searching the plurality of narrower band channels in parallel to find a plurality of narrower band channels having the synchronization pattern; and
determining whether any of the plurality of narrower band channels having the synchronization pattern are control channels.

21. The method of claim 20, further comprising:
determining a signal characteristic corresponding to each of the control channels; and
prioritizing the control channels based on the signal characteristic corresponding to each of the control channels.

22. The method of claim 21, further comprising:
selecting an appropriate control channel from the control channels that have been prioritized; and
registering with the base station server corresponding to the appropriate control channel.
